(19) United States
(12) Patent Application Publication
(10) Pub. No.: US 2005/0034606 A1
(43) Pub. Date: Feb. 17, 2005

(54) Coffee machine

(76) Inventor: Jean-Paul In Albon, Ardon (CH)

Correspondence Address: WENDEROTH, LIND & PONACK, L.L.P., 2033 K STREET N. W., SUITE 800, WASHINGTON, DC, 20006-1021, US

(21) Appl. No.: 10/806,324

(22) Filed: Mar. 23, 2004

(30) Foreign Application Priority Data
Aug. 15, 2003 (CH) 01 402/03

(51) Int. Cl. A23F 3/00

(52) U.S. Cl. 99/284

(57) ABSTRACT

A coffee machine is provided with a housing frame (10), with at least one extraction device (20) for production of the coffee, an electronic control unit (40) and a hot water or steam supply (50). The extraction device (20), the control unit (40) and the hot water or steam supply (50) are each assigned to a black box (62, 63, 64, 65) provided with at least one transponder or similar for recording certain data and/or registration of certain functional processes. The recorded data can be analysed, notably by a computer program. In this way the coffee machine can be optimally serviced and hence the lifetime of the individual functional units increased.

The invention concerns a coffee machine, with a housing frame and with functional units arranged therein, comprising at least an extraction device to produce the coffee, an electronic control unit and a hot water or steam supply.

Coffee machines of this type are prior art and available on the market in various embodiments. An especially advantageous coffee machine with several independent functional units which can be slid into a housing frame is disclosed, for example, in U.S. Pat. No. 5,957,033. The functional units form modules fitted with connector parts, which in the slide-in state are coupled with corresponding connector parts of the housing frame. The latter are connected with each other as desired via cables or wires. This coffee machine does allow a faulty module to be changed especially easily. However, faults detected too late can only be corrected by expensive repairs or even only by a complete change of module.

The present invention is based on the problem of creating a coffee machine of the type mentioned earlier which enables faults and thus operational stoppages to be largely avoided and to achieve an optimal maintenance or lifetime of the units.

This problem is solved according to invention by a coffee machine in which specifically several functional units each assigned a black box provided with at least one transponder to record specified data and register specified functional processes, where the recorded data can be captured by a computer.

Further advantageous embodiments of the coffee machine are the subject of the dependent claims.

Due to the fact that individual functional units are assigned a black box provided with at least one transponder to record specified data and register specified functional processes, whereby the recorded data can be captured by a computer, directly or via internet, the machine can be optimally maintained and hence the lifetime of the individual functional units is increased.

The monitoring and administration of service works is considerably simplified. Furthermore, the data can be statistically recorded and service departments world-wide can be unified especially if an internet connection is used.

The invention is explained in more detail below with the aid of the drawing. Shown are:

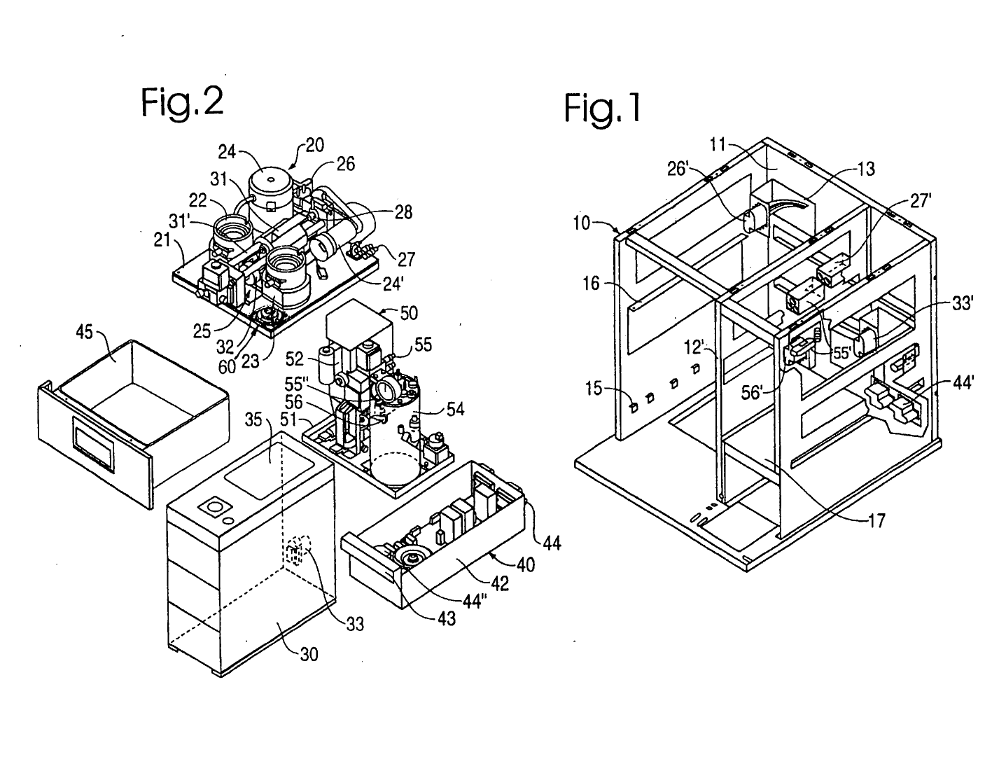

FIG. 1 a housing frame of a coffee machine according to the invention in perspective view;

FIG. 2 individual functional units which slide into the housing frame in perspective view;

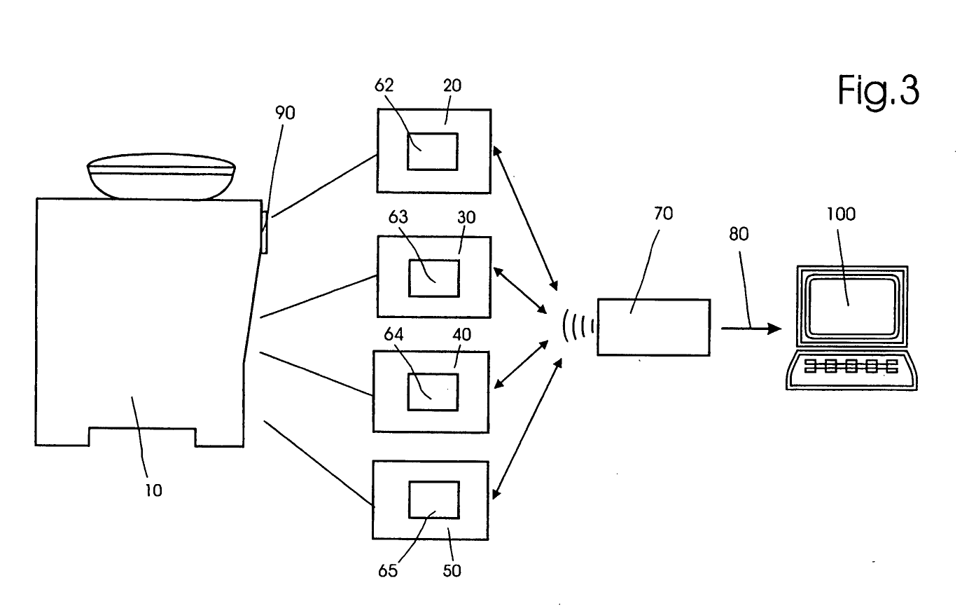

FIG. 3 a block diagram of the coffee machine according to the invention, and

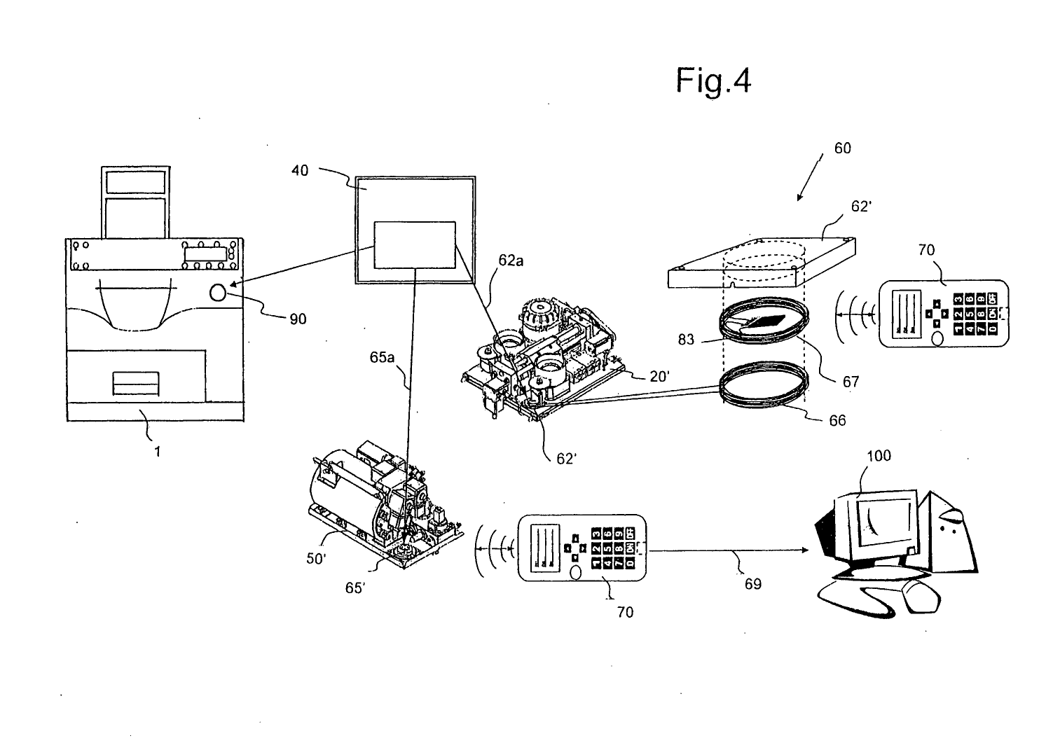

FIG. 4 a longitudinal section through a piston of the extraction device.

FIG. 1 shows a housing frame 10 of a coffee machine open at the front, with two side walls, a dividing wall 12′ and a rear wall 11. On the rear wall 11 are a number of connecting parts 55 described below, which are interconnected via cables or wires. The cable duct for these connection elements is designated as 13 in FIG. 1. One side wall and the dividing wall 12′ are provided with horizontal guide beads 15, 16, while on the other side of the dividing wall 12′ there is an intermediate base 17.

With this implementation of the housing frame 10 and also because of its dimensioning, a number of functional units as shown in FIG. 2, which form modules which are independent of each other, can be slid into the housing frame 10. The embodiment depicted concerns an extraction device 20 for producing coffee, a device 30 for producing milk foam, a control unit 40, a hot water and steam supply 50 and a collection container 45.

The principle of the extraction device 20 serving to produce coffee is prior art and is described in detail, for example in EP-B1-0 299 399. It is fixed to a support plate 21 and comprises a piston/cylinder unit 25, two grinders 22, 23, a driving member 24 to grind the coffee beans and connecting parts 26, 27 positioned on the back of the support plate 21, which are intended firstly to create an electrical connection and secondly to produce a water connection with an inlet and an outlet with this extraction device 20. There is also a motor 24′ for driving a threaded spindle 28, the latter being provided to regulate a brewing cylinder 31 of the piston/cylinder unit 25.

The piston/cylinder unit 25 consists of the aforementioned brewing cylinder 31 which is open at the front and guided on guide rods 31′ and of two pistons 32 guided therein, each having a piston rod, with one piston being disposed in a fixed position on the open front side of the brewing cylinder 31, while the other can be moved over a defined stroke. In addition to this, two lateral opposing openings are assigned to the brewing cylinder 31, each corresponding with the respective grinders 22, 23.

When producing coffee, the brewing cylinder 31 is brought by the driving member 24′ into a position in which it forms a hollow space delimited by the pistons, into which ground coffee is poured via the one lateral opening in a defined portion. Next the brewing cylinder 31 is moved towards the fixed piston 32 taking the movable piston with it. This reduces the hollow space to a predetermined volume and at the same time the coffee portion therein is compressed. In this position, hot water is pumped through the one piston into the hollow space and consequently through the portioned coffee and next the coffee produced is passed through the other piston to an outlet of the coffee machine.

After that, the brewing cylinder 31 and after a certain distance the movable piston too are pushed back, until the latter reaches the open cylinder end and the stationary piston 32 has been moved out of the brewing cylinder 31. The result of this is to eject the used portion of coffee and empty it into the collection container 45 disposed beneath this brewing cylinder 31. The brewing cylinder 31 is then returned to the original position.

The control unit 40 which forms a further module with electronic elements 44″ which are prior art and therefore not described in more detail, is accommodated in a drawer 42 with a handle 43 disposed on the front. Connector parts 44 are in turn disposed on the rear wall. This control unit 40 is further connected in a way which is not shown via a master switch to a mains connection.

A further independent module consists of the hot water and steam supply 50. Disposed on a support plate 51, this functional unit displays a water pump 52 together with a water heating container 54 (boiler). On the rear of the support plate 51 there are an electrical connection element 56 and a connector part 55 with inputs and outputs for the water connection. The latter connector part 55 contains (the same as the connector element 27 of the extraction device 20) a valve, not shown in more detail, which effects closure of the through-opening provided in the connector parts 55 and 27 respectively, when this is not plugged in. This ensures that when the module is taken out, any water in the container 54 does not run out. The water pump 52 suctions water from a pipe connected to the coffee machine and pumps it into the boiler 54 and, once it has been heated, either to the extraction device 20 or else directly to an outlet on the coffee machine which is provided for drawing hot water for tea or suchlike. To this end, there is an additional connecting part 55 on the front of the module 50, which is connected via a hose with the outlet in a way not shown. There can also be a connection to a steam outlet.

The device 30 which forms a further independent module for producing milk foam is only shown symbolically in FIG. 2; in its structure and method of functioning it corresponds for example to a device which is prior art from EP-A1-0 600 826. In principle, milk is poured into a container 35 fitted with a cover, the milk is heated therein and forced, together with separately supplied air suctioned via a suction line, through a resistance element, and in the foamy condition thereby produced it reaches an outlet chamber of the coffee machine. The device 30 is in turn equipped on its rear wall with a connector element 33.

The functional units or modules 20, 30, 40, 50 described above are slid into the housing frame 10 when the coffee machine is assembled at the points provided (as applicable, the extraction device 20 on the horizontal guide beads 15, 16, the hot water and steam supply 50 and the collection container 45 thereunder, the device 30 for producing milk foam on the intermediate base 17, the control unit 40 thereunder), until their connecting parts 26, 27 and 55, 56 and 33 and 44 respectively are coupled with corresponding connecting parts 26′, 27′ and 55′, 56′ and 33′ and 44′. Advantageously, a micro switch, not shown, is installed in the housing frame 10, which is activated by the collection container 45 in the inserted condition so that coffee can only be produced when the container is in this position.

According to the invention the extraction device 20, the control unit 40 and the hot water supply 50 are each assigned a black box 62, 63, 64, 65 fitted with a transponder or similar for recording certain data, with the recorded data in particular being analysed by a computer program.

According to FIG. 3, the black boxes 62, 63, 64, 65 are provided with transponders embodied as memories to capture and pass on various data, which can then be read off by means of a reader unit 70, captured and analysed by a computer 100.

The data transfer from the individual transponders via the reader unit 70 to the computer 100 can occur for example via USB connections 80. It can, however, also be conducted from the transponders via corresponding control modules directly over the internet to a service centre or similar where the data can be analysed and reply messages actuated or a service technician can be assigned for repair or maintenance. The computer 100, which can be provided in stationary or portable form, is provided with a computer program to analyse the data, through which the data can be retrieved and analysed using corresponding menus.

Thus for example the black box assigned to the extraction device 20 can record the number of motor activations to drive the brewing cylinder 31 and/or the grinders 22, 23, the number of valve openings of the connecting part 27 for the water connection, or record the replacement of a certain part.

Similarly the black box 65 can monitor and record the individual parts of the hot water and steam supply 50 and their function and also the water consumption for coffee production, tea or similar or steam generation. The black box 63 can register the number of processes for production of milk foam [and] the individual parts can be monitored. With the black box 64, all control processes can be registered.

The data recorded allows optimal maintenance of the coffee machine, as the result of which certain faults can be largely prevented. The lifetime of the individual functional units can thus be considerably increased and the costs of replacement modules reduced. The monitoring and administration of the service works is considerably simplified. Moreover, the data can be statistically recorded and service departments world-wide can be unified. For example, data from a 5-year operation of the coffee machine or data concerning 2.5 million cycles can be captured and statistically analysed.

In some circumstances, access to the coffee machine should only be granted to authorised personnel, which is why the coffee machine can be equipped with an authorisation identification system, advantageously a reader 90 of proximity or insertable identity cards. In the coffee machine according to the invention the reader 90 can for example be disposed under a housing cover covering the front opening of the housing frame 10 or a control panel thereof.

In the block diagram according to FIG. 4, the coffee machine 1 and two such functional units, specifically the extraction device 20′ and the hot water and steam supply 50′, are shown. These functional units have already been explained in more detail above and depicted accordingly in similar form in FIG. 1.

Diverse functional processes and time lapses are measured on the individual functional units and corresponding data is recorded in a central control unit 40 (CPU—central processing unit). Thus for example in the case of the extraction device 20′ for producing the coffee—as already mentioned—the number of motor activations to drive the brewing cylinder and/or the grinders, the number of valve openings for the hot water feed, the changing of a certain part etc. can be registered. In the case of the hot water and steam supply 65′ for example the water consumption for coffee production or tea, or for steam generation can be registered, or marches of pressure and/or temperature measured.

The data determined is sent encrypted by the central control unit 40 to devices according to the invention 60 for electronic recording of this data, which are attached to the individual functional units. The devices 60 are in the form of so-called black boxes 62′ with components integrated therein. Each device 60 displays a first coil 66, which is provided for reception of the coded data, and which is connected via a cable 62a, 65a with the control unit 40. The black box 62′ further contains a second coil 67, which is in an electromagnetic effective connection with the first coil 66 and to which a transponder chip 83 is connected. The transponder chip 83 is in the form of an EEPROM (electrically erasable programmable read-only memory) and operatively connected with a reader unit 70, by which the data stored on the transponder chip 83 is firstly read off and secondly can then be deleted or reset to zero. After deletion, the transponder chip 83 can be overwritten.

As indicated schematically in FIG. 4, the data recorded by the reader unit 70 can be passed on via a network connection 69, for example via USB connections or—and advantageously—via the internet, to a computer 100 for analysis.

Access to the data should only be granted to authorised personnel, hence the coffee machine is equipped with an authorisation identification system 90, advantageously a reader of proximity or insertable identity cards.

The recorded data enables optimal maintenance of the coffee machine 1, so that certain defects can be largely prevented. The lifetime of the individual functional units can thereby be considerably increased and the costs for replacement modules reduced. The monitoring and administration of service works is considerably simplified. Moreover, the data can be statistically recorded and service departments world-wide can be unified. For example, data from a 5-year operation of the coffee machine or data concerning 2.5 million cycles can be captured and statistically analysed.

Since the individual devices embodied as black boxes 60 are connected via cables 62a, 65a with the central control unit 40, which registers certain functional processes and time lapses, the corresponding encrypted data can be sent very simply to the individual devices 60, stored on the transponder chip 83 with the cooperation of the two coils 66, 67, and read off by the reader unit 70 (or reader units) for corresponding analysis.

In principle, the device could also display three or even more coils integrated in a black box and isolated from each other, of which the first coil is electrically connected with the CPU, a second also with this CPU or with a further CPU and the third to the transponder chip, again in the black box.

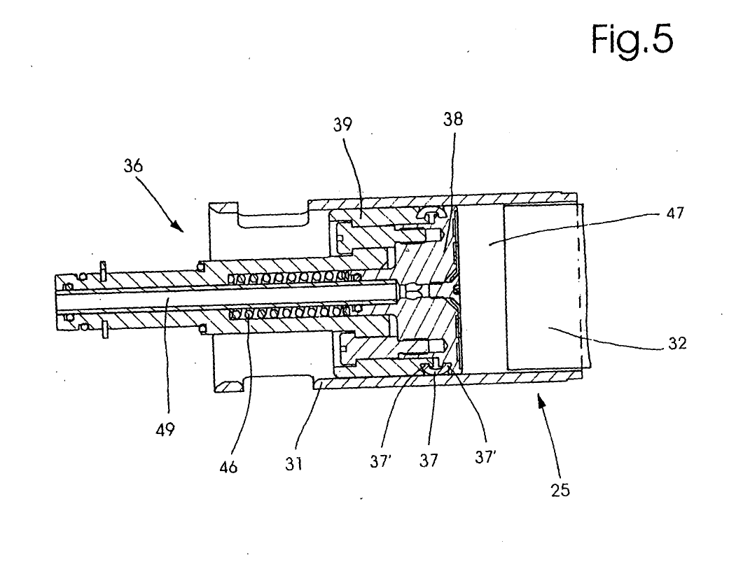

FIG. 5 shows another two-part cylinder 36 according to the invention of the piston/cylinder unit 25. This piston 36 displays a front and a rear piston part 38, 39, which are connected to each other on the outer sheath by a seal 37 with a U-shaped cross section. This U-shaped seal 37 is fixed all round on its end lips 37′ to one or other piston part 38, 39. These two piston parts 38, 39 are forced apart by a pressure spring 46, positioned between them in the initial position as shown, in such a way that the seal 37, seen in cross-section, is extended lengthways. At the same time in operating condition during brewing, the rear piston part is pressed against the front piston part 39, 38, so that the lips 37′ are moved towards each other and consequently the seal is moved outwards, so that an all-round seal is created between the piston and the cylinder 31. As soon as this seal has been induced, the brewing process can commence, by allowing hot water through a central opening 49 in the piston 36 and conducting it into the hollow space 47 formed between the two pistons 32, 36, into which the ground coffee has previously been poured and which has been sealed by the two pistons 32, 36.

The coffee machine according to the invention, in which the functional units forming the individual independent modules are provided with black boxes, is especially advantageous and because of the ease of dismantling, enables especially simple maintenance. However, even in coffee machines not of modular design, the individual functional units could be equipped according to the invention with black boxes for recording certain data and registering certain functional processes.

It would also, however, certainly be possible to arrange a black box on the housing frame or chassis of the coffee machine (e.g. in coffee machines with water pumps attached to the chassis or in other functional units fixed to the housing frame, such as for example a control panel with push buttons).

In principle, the extraction device can also be embodied as a filter arrangement producing the coffee or a piston with powder poured in, or with insertable coffee capsules.

The [means] of interrogating the recorded data are advantageously only accessible through corresponding identification systems such as passwords or similar.

The black boxes 62, 63, 64, 65 are each designed in such a way that error messages and the status of the coffee machine can also be recorded with them.

1-18. (Cancelled)

19. Coffee machine with at least one extraction device for producing coffee, an electronic control unit and a hot water and/or steam supply, wherein the extraction device, the control unit and/or the hot water respectively the steam supply are each assigned a black box provided with at least one transponder or similar to record certain data and/or register certain functional processes, while the recorded data can be analyzed in particular by a computer program.

20. Coffee machine according to claim 19, wherein the data of the black boxes stored in the transponders which are in the form of memory can be captured and transferred directly or via a network connection, advantageously the internet, to a computer for analysis.

21. Coffee machine according to claim 20, wherein the data stored in the transponders can be read off by means of a wireless or a cable-connected reader unit.

22. Coffee machine according to claim 19, wherein the data transfer from the transponders can be conducted via control modules directly via the internet into a mainframe or similar in which this transmitted data is analyzed and, where necessary, replies are sent or a service technician is notified to provide repair or maintenance.

23. Coffee machine according to claim 19, wherein the black boxes are attached onto functional units of the coffee machine forming independent modules, which can be slid into the housing frame and are provided with connection parts which are coupled in the slid-in condition with corresponding connection parts of the housing frame.

24. Coffee machine according to claim 23, wherein the functional units fixed to the housing, which are designed as extraction device for production of coffee, as electronic control unit, as hot water or steam supply or others, are each assigned a black box.

25. Coffee machine according to claim 19, wherein, in the case of the extraction device for producing coffee, the number of motor activations for driving the brewing cylinder and/or the grinders, the number of valve openings for the hot water feed and/or other values are recorded in the black box.

26. Coffee machine according to claim 19, wherein, in the case of the electronic control unit (40), functional processes and time lapses are recorded in the black box on actuation.

27. Coffee machine according to claim 19, wherein for each of the black boxes is designed in such a way that it can be used to record error messages and the status of the coffee machine.

28. Coffee machine according to claim 19, wherein for the hot water or steam supply, the water quantities, marches of pressure and/or temperature or other values are recorded in the black box.

29. Coffee machine according to claim 19, wherein a reader of proximity or insertable identity cards is included.

30. Coffee machine according to claim 19, wherein the black boxes are attached to the housing frame or chassis.

31. Coffee machine according to claim 19, wherein the extraction device has a piston-cylinder unit with a brewing cylinder and with a two-part piston, where this piston displays a front and a rear piston part which are connected with each other on their outer sheath by a seal with a U-shaped cross-section, where the latter is fixed all around on the lips on its end to one or other piston part.

32. Device for electronic recording of certain data, in particular for individual functional units, incorporating a transponder chip with firstly a data source and secondly a reader, wherein the device displays a number of coils disposed in a black box and isolated from each other, of which a first coil is connected electrically with a control unit acting as a data source, registering certain functional processes and time lapses, where the transponder chip is also integrated into the black box and connected to the second coil which has an electromagnetic effective connection with the first coil.

33. Device according to claim 32, wherein the transponder chip is in the form of an EEPROM (electrically erasable programmable read-only memory).

34. Device according to claim 33, wherein the data stored on the transponder chip can be read off using a reader.

35. Device according to claim 33, wherein the data stored on the transponder chip can be deleted and the transponder chip is designed to be overwritten.

36. Application of the device according to claim 32, for a coffee machine displaying a number of functional units, wherein the individual functional units are provided with their own devices connected via cables to the control unit and designed in the form of a black box.

37. Device according to claim 34, wherein the data stored on the transponder chip can be deleted and the transponder chip is designed to be overwritten.

38. Application of the device according to claim 33, for a coffee machine displaying a number of functional units, wherein the individual functional units are provided with their own devices connected via cables to the control unit and designed in the form of a black box.

39. Application of the device according to claim 34, for a coffee machine displaying a number of functional units, wherein the individual functional units are provided with their own devices connected via cables to the control unit and designed in the form of a black box.

40. Application of the device according to claim 35, for a coffee machine displaying a number of functional units, wherein the individual functional units are provided with their own devices connected via cables to the control unit and designed in the form of a black box.
